(19) United States
(12) Patent Application Publication
(10) Pub. No.: US 2016/0224740 A1
(43) Pub. Date: Aug. 4, 2016

(54) Text Message Based Monitoring and Data Collection System

(71) Applicant: Florida Institute for Human and Machine Cognition, Inc., Pensacola, FL (US)

(72) Inventors: James F. Allen, Pensacola, FL (US); Hyekyun Rhee, Pensacola, FL (US)

(73) Assignee: Florida Institute for Human and Machine Cognition, Inc., Pensacola, FL (US)

(21) Appl. No.: 15/014,138

(22) Filed: Feb. 3, 2016

Related U.S. Application Data
(60) Provisional application No. 62/111,363, filed on Feb. 3, 2015.

(51) Int. Cl. G06F 19/00; H04W 4/14

(52) U.S. Cl. CPC G06F 19/345; H04W 4/14; G06F 19/322; G06F 19/3456

(57) ABSTRACT

An SMS-based human/computer interface that may be applied to a wide variety of tasks. The interface allows a human user to interact with a computer system using SMS messages. The user sends messages to the computer system and receives messages from the computer system in a format that would normally be used for interacting with a human acquaintance. The computer system includes a natural language processor with an associated lexicon of conventional language (such as English words) and SMS-unique language. The language processor determines the user's meaning and the system then generates responses that are appropriate within the present context The computer system includes the ability to bring in a human operator when conditions warrant such an intervention.

### CROSS-REFERENCES TO RELATED APPLICATIONS

This non-provisional application claims the benefit of provisional patent application Ser. No. 62/111,363. The provisional application listed the same inventors.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of human/machine interfaces. More specifically, the invention comprises a text-message-based condition monitoring and data collection system that allows a human to interact with a computer system in a manner that is familiar to users of text messages.

2. Description of the Related Art

Short Message Service (“SMS”) is a text messaging protocol used by cellular phones and other mobile communication devices. “Text messaging” and “SMS messaging” are synonyms for the same functionality. This communication protocol allows a user to send a test message using a 12 character numeric keypad or a full text keypad.

Traditional cell phone voice communications maintain an open “channel” whether information is being sent or not. If two persons are having a conversation over a cellular link, a significant portion of the time will be “dead air” in which no meaningful information is being transferred. Digital compression techniques have reduced the bandwidth requirements of “dead air,” but the maintenance of an open channel is still relatively inefficient.

SMS, on the other hand, represents a burst transmission of data with, practically no “dead air.” For this reason SMS tends to be much cheaper than voice communications. This disparity in price may have initially promoted the use of SMS by young persons, though the more discrete nature of SMS messaging may be equally responsible for the tremendous popularity of this medium among teens. In any event, it is now well established that teens prefer text-messaging to every other option.

SMS grew rapidly during a period when most uses employed numeric keypads rather than full text keypads. Perhaps as a result of the inconvenience of creating words using a cumbersome input format a whole list of user-created abbreviations gained wide acceptance. Examples include “lol” (“laugh out loud”), “l8r” (“later” or “see you later”), and “gr8” (“great”). Though most users now employ full keypads, the abbreviations have become part of “SMS culture” and they persist. This fact is significant to any human/machine interface that is based on SMS, as lexicons and ontologies created for human speech or human writing must be altered to function well in the world of SMS.

An SMS-based interface for a computer system is desirable for several reasons. First, teens and even younger children are very comfortable with the SMS communication format. Second, a human user who sends and receives SMS messages does not expect to “see” the other entity in the communication. Thus, a well-designed computer-based response may be made to look like a normal human-to-human SMS interaction. Third, a well-designed system can mix human and machine-generated content in a way that is not necessarily discernible to a human user.

The present invention provides an SMS-based human/computer interlace for performing a variety of tasks. It is configured to interact with the human user in a way that feels like a normal human-to-human interaction. Thus, while the human user may know that be or she is interacting with a computer system, the interaction will feel more natural.

### BRIEF SUMMARY Of THE INVENTION

The present invention comprises an SMS-based human/computer interface that may be applied to a wide variety of tasks. The interface allows a human user to interact with a computer system using SMS messages. The user sends messages to the computer system and receives messages from the computer system in a format that would normally be used for interacting with a human acquaintance. The computer system includes a natural language processor with an associated lexicon, of conventional language (such as English words) and SMS-unique language. The language processor determines the user's meaning and the system then generates responses that are appropriate within the present context.

The computer system includes the ability to bring in a human operator when conditions warrant such an intervention. In one exemplary embodiment the invention is used to gather data and give advice regarding a human user's medical condition(s). If the computer system in this embodiment determines that a medically significant or urgent situation exists, the system may bring in a trained human operator for further evaluation and possible action. The integration of the human operator is seamless from the standpoint of the user, who just continues to send and receive SMS messages that are appropriate for the context.

The invention may be applied to many tasks beyond the field of medicine, for example, the invention may be used to monitor and lend advice to a user performing machine maintenance tasks or traveling in an unfamiliar area. The specific implementation for each task will of course be different but the general concepts will remain the same.

### BRIEF DESCRIPTION OF THE SEVERAL VIEWS OF THE DRAWINGS

FIG. 1 shows a plan view of a cell phone with a user interface configured to carry out the present invention.

FIG. 2 shows a text-message-based exchange using one embodiment of the present invention.

FIG. 3 shows a continuation of the text message exchange from FIG. 3.

FIG. 4 shows a text message exchange configured to collect data.

FIG. 5 shows a text message exchange initiated by a patient.

FIG. 6 shows a continuation of the text message exchange of FIG. 5.

FIG. 7 shows a block diagram depicting the components of one inventive embodiment and how they interact.

### REFERENCE NUMERALS IN THE DRAWINGS

10 patient communication device
12 user interface
14 query
16 response
18 patient initiated input
20 auxiliary communication device
22 system server
24 language processor
26 first communication link
28 second communication link
30 third communication link
32 fourth communication link
34 human operator

### DETAILED DESCRIPTION OF THE INVENTION

The present invention incorporates a variety of concepts which are difficult to initially grasp in the abstract Accordingly, this description will begin with a specific example. Once the application of the invention to this specific example is initially explored, a more general description of the system architecture will be provided.

The invention is well suited to applications in the medical field. Mobile phone-based disease management is a good example. This is particularly true for chronic disease management where accurate record-keeping regarding symptoms and treatments can be very helpful. Asthma and diabetes are two chronic diseases where record-keeping is helpful. For example, it is often helpful for asthma patients and/or their medical providers to correlate activities with symptoms. In addition, if is often helpful to correlate treatments provided with the results they produce.

To these ends, an asthma management system might have the goals of (1) collecting data regarding symptoms, (2) collecting data regarding activities of daily Living, (3) collecting data regarding treatments applied, (4) providing advisory information, (5) notifying parents or other caregivers of present conditions and trends, and (6) bringing in trained personnel where human judgment or intervention is needed.

The invention is typically implemented by providing a computer system, that receives and sends SMS texts to a human user. The human user commonly carries a mobile communication device such as a “smart phone.” Asthma management is a particular challenge for teenagers. Over ¾ of all teenagers (ages 12-17) have a cell phone that is capable of sending and receiving SMS messages. Thus, this method of communication can reach most people.

The inventive system includes a natural language processor that is capable of interpreting normal human-generated SMS messages in order to determine the intended meaning. Further, the language processor is capable of creating and sending messages that are appropriate for the context, so that the human user perceives the computer system as a human-to-human interaction rather than a human-to-machine interaction.

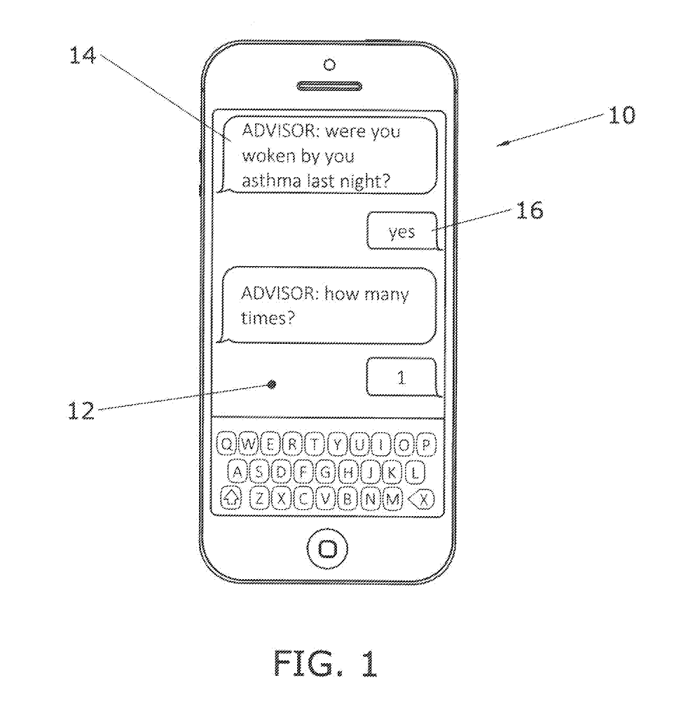

The system is preferably able to initiate a string of communications and to respond to a communication initiated by a human user. FIG. 1 depicts a machine-initiated transaction. Patient communication device 10 has a touch-screen display that is displaying a familiar user interface 12. This interface has a message area on its upper -portion and a virtual keypad on its lower portion.

In this example, the inventive system is programmed to ask questions at certain times of the day in order to gather data. Query 14 represents the system making a request using natural language (“Were you woken by your asthma last night?”). The user types and sends response 16 (“yes”). The natural language processor receives and interprets this response. The system then acts on the response by requesting additional information (“How many times?”). The user then responds again (“1”).

The response “1” serves to illustrate the advantages of using a natural language processor. The user might naturally respond to the query in a variety of ways yet still intend the same meaning. Examples include “once,” “one time,” or “1.” To a human listener, these responses are equivalent. Yet, in the context of a variable being plugged into a line of software, the responses would not be equivalent. The natural language processor discerns the meaning and converts the response to a predefined format (such as a whole number).

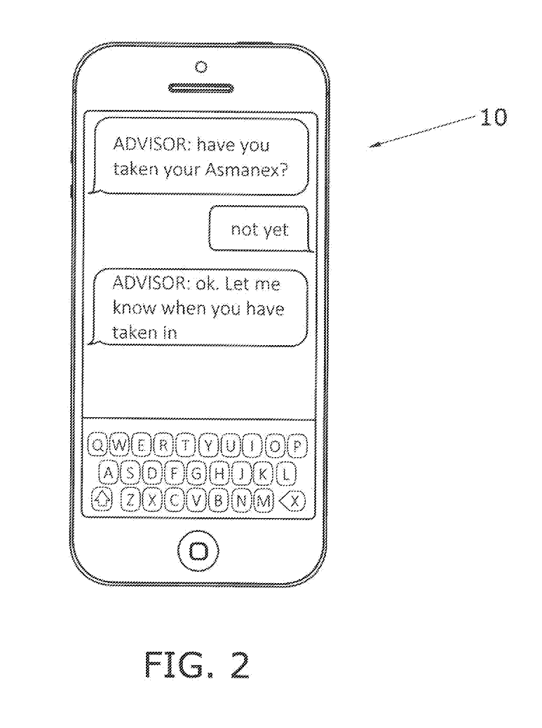

FIG. 2 shows another example of a “timer” function. The system is programmed to know when the human user is supposed to take certain medications. The user is able to type this information into the phone and send it unprompted (“took my meds). If the system receives no indication the system will send an SMS query (“Have you taken your Asmanex?”). The human user responds and the machine interprets the response. For example, the natural language processor might interpret the SMS response “Not yet” as “N” and feed that response into the control software to decide what to do next. The control software generates a response which is then placed in a natural language format (“OK. Let me know when you have taken it”).

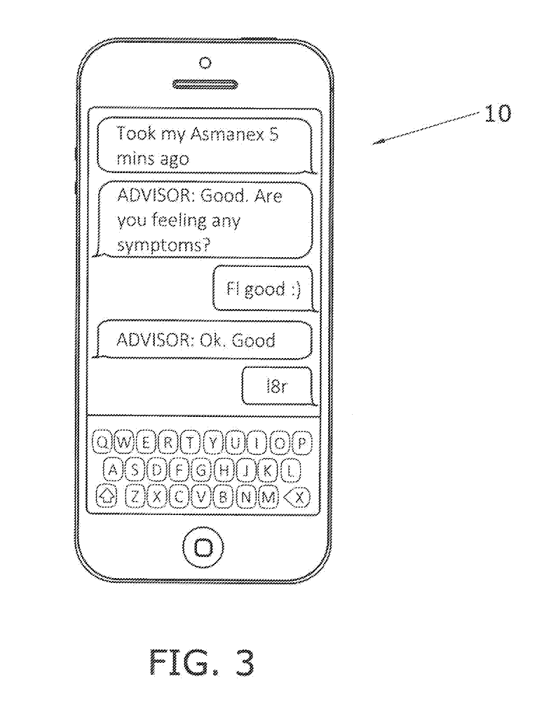

FIG. 3 shows the interface when the user has taken the medication and responds (“Took my Asmanex 5 mins ago”). The natural language processor interprets this information and concerts it to a code-readable format such as: “Med1: Y: Time:0845.” Note in this example that the system used the time stamp in the message and the user information that the medication was taken “5 minutes ago” to determine a proper time to log for taking the medication. This is an example of how the language processing can use context-based data to infer other data.

The program then responds with another message which the language processor puts in context (“Good. Are you feeling any symptoms?”). The user responds with an SMS-shorthand and an emoticon (“Fl good :)”). The language processor interprets this simply as a “No” response to the question of whether the human user is feeling any symptoms. The system then generates another message (“OK.Good”). The user then signs off with “l8r” (“see you later”).

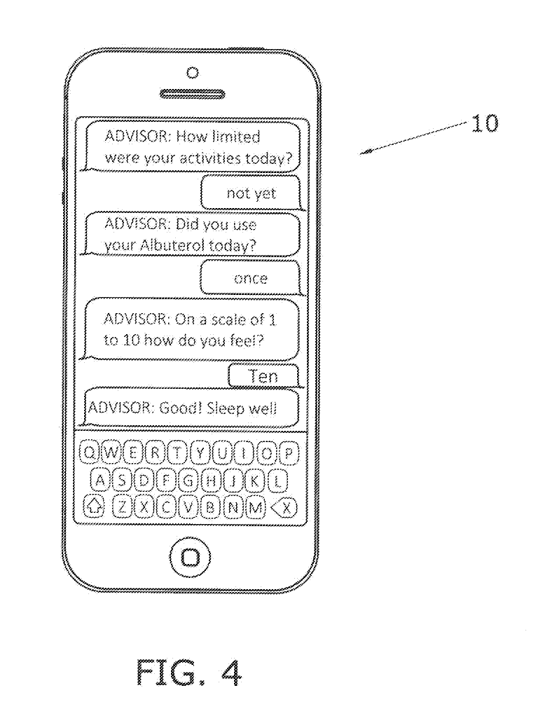

Toward the end of the day the inventive system may be programmed to seek data regarding the user's general symptoms for that day. FIG. 4 shows a query intended, to engage the user and collect this information (“How limited were your activities today?”). The user responds vaguely (“Not bad”) so the system asks more specific questions (“Did you use your Albuterol today?” etc.). The natural language processor responds with test that is not needed for the data collecting purposes but which helps to emulate normal patterns of human communication (“Good! Sleep well”). The human emulation tends to promote easier and more natural communication between the user and the inventive system.

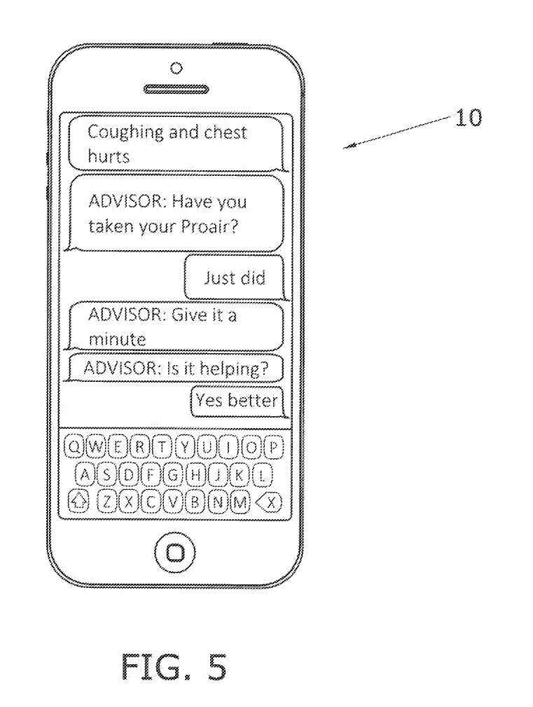

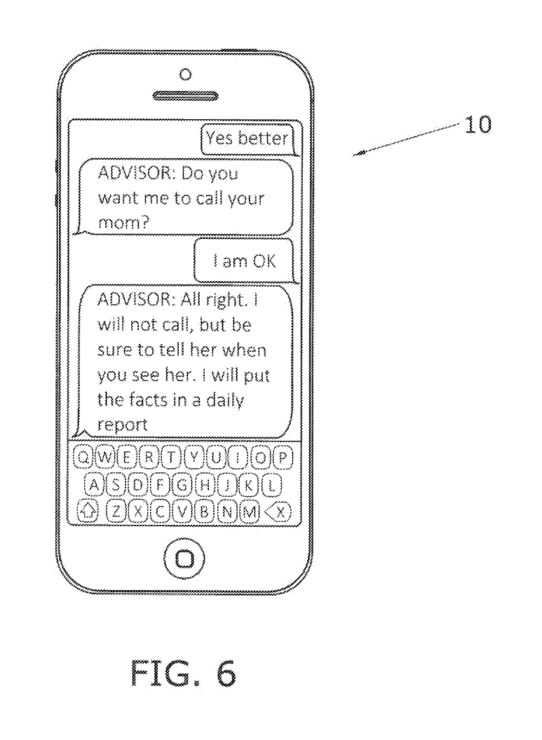

The preceding examples all involved computer-initiated exchanges, but the inventive system supports human user-initiated exchanges as well. FIGS. 5 and 6 provide an example of this. In FIG. 5, the user has awoken with a cough and chest pain. She types and sends patient initiated input 18. The language processor processes this information and sends it to the control program. The control program interprets this information as abnormal and potentially problematic so it alerts a trained human operator. The human operator preferably has training in the particular condition (asthma) and some knowledge of the patient's history. At this point the human operator takes over and types in a query (“Have you taken your Proair?”). The reader will note that this transition is seamless from the perspective of the human user. The human user does not know whether the SMS messages are generated by the language processor or a human operator.

Continuing the example, the user responds (“Just did”). The human operator then gives some advice (“Give it a minute”). Sixty seconds then pass with no further communication so the human operator prompts another response (“Is it helping?”). The human user then confirms that it is (“Yes better”).

The example continues in FIG. 6. In this embodiment the inventive system has access to a database of contact persons and information regarding if and when such persons should be contacted. The human operator is given that information, so she next types “Do you want me to call your mom?” The user responds (“I am OK.”). The human operator then provides another response (“Allright. I will not call, but be sure to tell her when you see her. I will put the facts in a daily report.”).

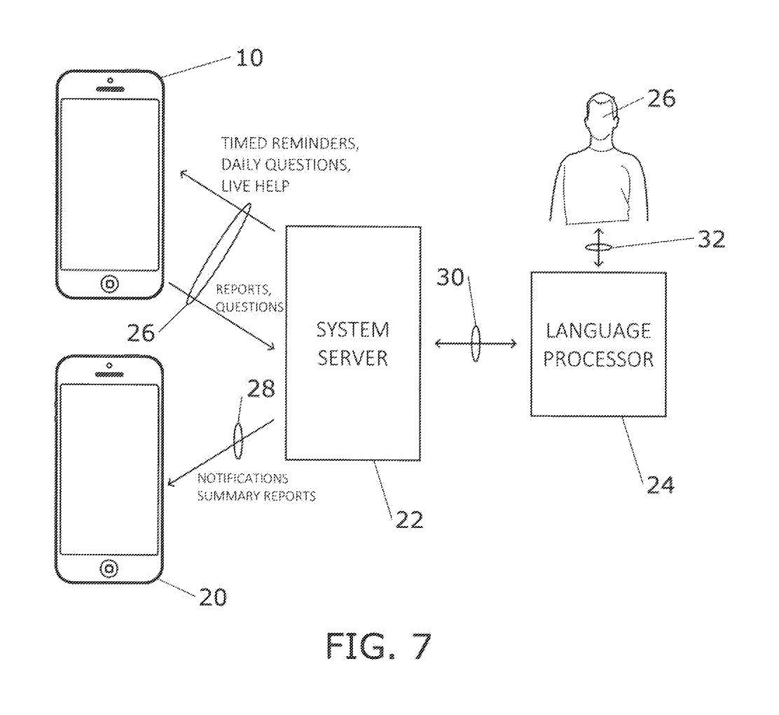

FIG. 7 shows a block diagram of the major components assembled to create the interactions depicted in FIGS. 1-6. Patient communication device 10 in this example is a “smart phone” carried by the human user. It communicates with system server 22 via first communication link 26. First communication link 26 is most commonly a cellular network, hut it may assume other forms. The first communication link carries reminders and questions from system server 22 to patient communication device 10. It also carries responses from the user in the other direction.

System server 22 includes one or more processors running software that regulates and controls the inventive process,. Language processor 24 is associated with the system server. The language processor contains a lexicon of normal human communications and enhancements specific to SMS-based communication. The language processor may also contain ontologies, decision trees, and other known language processing devices that are able to determine context-specific meaning tor each communication fern the human user.

System server 22 preferably communicates with auxiliary communication device 20 over second communication link 28. The second communication device is one associated with a designated person such as a parent or medical provider. This link typically carries notifications and summary reports. Third communication link 30 is shown between system server 22 and language processor 24, thought it is certainly possible that the language processor is run by the same computer hosting the balance of the system.

Fourth communication link 32 in this example links human operator 26 to the language processor and the balance of the system. The human operator may be one of many trained operators capable of taking over an exchange with a user when conditions warrant. When the language processor detects a predefined abnormal condition (such as a string of texts with no discernible meaning or an indication of a significant medical problem) it alerts the human operator. The system preferably provides enough context for the human operator to seamlessly take over. For example, the human operator may be provided with a multi-monitor “dispatcher” console. The system would then display the most recent exchange of SMS messages, the patient history, and any other relevant information. The human operator would then take over.

Once the situation prompting the intervention of the human operator is resolved, the human operator is able to return control of the communications to the system server. Normal communications then resume. The block diagram depicted in FIG. 7 is one way among many different possibilities of implementing the inventive system and should not be viewed as limiting. A single computer system could host both the communication links and the language processor. On the other hand the term “system server” might encompass multiple computer systems configured to communicate with each other.

In a preferred embodiment of the invention a “daily parent report” is provided to auxiliary communication device 20. This report summarizes a day's activity and allows a parent or guardian to monitor the patient's condition in an unobtrusive way. The inclusion of this daily report can help facilitate effective communication in a parent-teen partnership. The report can obviously assume many forms, but representative content is as follows:

1. An indicator of overall control of the medical condition such as asthma (“poorly controlled,” “somewhat controlled,” or “well controlled”);

2. An indicator of the level of physical activity (“sedentary,” “somewhat active,” or “very active”);

3. Frequency of rescues medication use; and

4. Frequency of control-medication use.

The “daily parent report” is typically provided to a parent or guardian. However, an option could be provided to share this report with one or more medical providers as well. The report could also be accumulated into trend information tor either the parent/guardian or the medical provider.

An embodiment of the inventive system used in this context may include the following attributes:

1. “Timer” functions where the system ensures that the user has performed a specific act like taking a medication;

2. Data collection functions where the system asks the user about his or her condition and activities that are desirable to correlate to the condition; and

3. Advise functions where the system provides context-sensitive knowledge and instructions.

The same principles can be applied to many different tasks outside the field of disease monitoring. For example, the inventive system could be used to monitor a student's progress through course materials. The “timer” functions would ask the user whether assignments in the coursework had been completed and prompt the user for this information. Data collection functions might ask the user to report a page number that be or she has completed in the assigned reading. The advice functions might tell the student where she is in relation to other members of the class—without revealing any specific identities of other students.

In this context the human operator might be an assigned teaching assistant. If it appears that the student is in trouble on some particular point the teaching assistant could assume control of the system-originating SMS messages and interact with the student. Again, the assumption by the human operator would preferably be seamless.

From these examples one may generalize some of the characteristics of the inventive system as follows:

1. SMS-based communications to and from the inventive systems;

2. Natural language based communications that emulate communications normally occurring between two humans;

3. The availability of a human operator who can intervene and take over the machine-generated communications; and

4. The ability to interact with multiple different communication devices, such as a parent or supervisor being informed of the user's actions.

Not every embodiment will include every characteristic on this list. However, the reader will discern the advantages of the inventive system. The descriptions of specific embodiments should not be construed as limiting the scope of the invention but rather as providing illustrations of the preferred embodiments of the invention. Thus, the scope of the invention should be fixed by the claims ultimately drafted, rather than by the examples given.

Having described our invention, we claim:

1. A medical condition, monitoring and advisory system for use by a medical patient and a designated third person, comprising:
a. a smart phone for use by said medical patient;
b. an auxiliary communication device for use by said designated third person;
c. a system server in communication with said smart phone via a first communication link and in communication with said auxiliary communication device via a second communication link;
d. a language processor in communication with said system server, including,
i. a lexicon of normal human communications,
ii. an enhanced lexicon specific to SMS communications,
iii. said language processor being configured to receive natural language SMS-based inputs from said human user and convert them to a code-readable format,
iv. said language processor being configured to receive code-readable messages and convert them into SMS-based natural language;
e. said system server being configured to receive SMS-based natural language inputs from said user, use said language processor to convert said natural language inputs to said code-readable format, process said inputs in said code-readable format, use said language processor to format an SMS-based natural language response, and transmit said response over said first communication link; and
f. said system server being configured to monitor for a predefined abnormal condition, and upon detecting said predefined abnormal condition notify a trained, human operator with said system server then configured to allow said trained human operator to then replace said language processor in communicating with said user via said system server and said first communication link using SMS-based natural language generated by said trained human operator.

2. The medical condition monitoring and advisory system as recited in claim 1, wherein upon said detection of said predefined abnormal condition said system server is configured to notify said designated third person via said second communication link.

3. The medical condition monitoring and advisory system as recited in claim 1, wherein said system server is also configured to create a daily summary of communications with said patient.

4. The medical condition monitoring and advisory system as recited in claim 3, wherein said system server is configured to transmit said daily summary to said designated third person.

5. The medical condition monitoring and advisory system as recited in claim 1, wherein said system server is configured to initiate communication with said patient using said SMS-based natural language.

6. The medical condition monitoring and advisory system as recited in claim 5, wherein said communication is initiated at a particular time of day.

7. The medical condition monitoring and advisory system as recited in claim 5, wherein said communication is initiated according to said patient's medication schedule.

8. The medical condition monitoring and advisory system as recited in claim 1, wherein said first communication link is a cellular phone link.

9. The medical condition monitoring and advisory system as recited in claim 1, wherein said first communication link is a WiFi link.

10. The medical condition monitoring and advisory system as recited in claim 1, wherein said natural, language processor includes decision trees configured to determine a meaning for said SMS-based natural language inputs.

11. A medical condition monitoring and advisory system for use by a medical patient and a designated, third person, comprising:
a. a smart phone for use by said medical patient, including input functionality allowing said patient to input and transmit SMS-based messages;
b. an auxiliary communication device for use by said designated third person;
c. a system server in communication with said smart phone via a first communication link and in communication with said auxiliary communication device via a second communication link;
d. said system server having access to a language processor, including,
i. a lexicon of normal human language,
ii. an enhanced lexicon specific to SMS-based language,
iii. said language processor being configured to receive natural language SMS-based inputs from said human user and convert them to a code-readable format,
iv. said language processor being configured to receive code-readable messages and convert them into SMS-based natural language;
e. said system server being configured to receive SMS-based natural language inputs from said user, use said language processor to convert said natural language inputs to said code-readable format, process said inputs in said code-readable format, use said language processor to format an SMS-based natural language response, and transmit said response over said first communication link; and
f. said system server being configured to monitor for a predefined abnormal condition, and upon detecting said predefined abnormal condition notify a trained human operator with said system server then configured to allow said trained human operator to then replace said language processor in communicating with said user via said system server and said first communication link using SMS-based natural language generated by said trained human operator.

12. The medical condition monitoring and advisory system as needed in claim 11, wherein upon said detection of said predefined abnormal condition said system server is configured to notify said designated third person via said second communication link.

13. The medical condition monitoring and advisory system as recited in claim 11, wherein said system server is also configured to create a daily summary of communications with said patient.

14. The medical condition monitoring and advisory system as recited in claim 13, wherein said system server is configured to transmit said daily summary to said designated third person.

15. The medical condition monitoring and advisory system as recited in claim 11, wherein said system server is configured to initiate communication with said patient using said SMS-based natural language.

16. The medical condition monitoring and advisory system as recited in claim 15, wherein said communication is initiated at a particular time of day.

17. The medical condition monitoring and advisory system as recited in claim 15, wherein said communication is initiated according to said patient's medication schedule.

18. The medical condition monitoring and advisory system as recited in claim 11, wherein said first communication link is a cellular phone link.

19. The medical condition monitoring and advisory system as recited in claim 11, wherein said first communication link is a WiFi link.

20. The medical condition monitoring and advisory system as recited in claim 11, wherein said natural language processor includes decision trees configured to determine a meaning for said SMS-based natural language inputs.
